(19) United States
(12) Patent Application Publication
(10) Pub. No.: US 2009/0273431 A1
(43) Pub. Date: Nov. 5, 2009

(54) Lower cost continuous flux path transformer core and method of manufacture

(76) Inventor: John Shirley Hurst, Indian Trail, NC (US)

Correspondence Address: Jurgen Vollrath, 5 Blossom Circle West, Rochester, NY, 14610, US

(21) Appl. No.: 12/151,066

(22) Filed: May 2, 2008

(51) Int. Cl. H01F 27/24; H01F 41/02

(52) U.S. Cl. 336/216; 336/233; 29/607

(57) ABSTRACT

In a continuous flux path transformer core, at least part of the core is implemented in non-grain oriented steel.

### FIELD OF THE INVENTION

The present invention relates to transformer designs. In particular it relates to transformers with a continuous flux path.

### BACKGROUND OF THE INVENTION

Transformers operate on the principle that when two wires are arranged in proximity to each other and an alternating current is passed through one of the wires, an alternating current is induced in the other wire by an effect known as electromagnetic induction. By winding the wires into coils and placing them along a common axis the amount of electromagnetic coupling and thus the amount of induced current will be increased over straight, parallel wires. The coupling is increased yet further by winding the two coils on top of each other. The coupling can also be increased by placing a ferromagnetic substance, referred to as a core, within the coils.

Over time cores have been improved to minimize losses. In the case of low frequency applications in order to reduce eddy currents that cause heat losses, steel cores are typically implemented in layers. At higher frequencies, above the audio frequency range, the benefits of laminated steel cores are however overtaken by hysteresis losses, making powdered iron cores more attractive.

The present application deals specifically with low frequency applications, in particular with power transformers used in the national grid (typically 50-60 Hz). The application therefore focuses specifically on laminated steel cores, and in particular three phase power transmission.

In the United States electrical power intended for commercial and industrial applications is produced as three phase. For home use the power is typically also generated as three phase but in most applications only one phase is used, the other phases being used for other homes.

Three phase power is typically provided by making use of two sets of windings, the primary being connected to the power supply and the secondary to the load. Each of the windings is either connected as a delta connection (FIG. 1) or a wye connection (FIG. 2).

A variety of core configurations have been developed over the years, including the E-core, as shown in FIG. 3, which includes a three-legged section 300 in the form of an E and a bar section 302 that closes the open side of the E-section.

E-cores are universally used at 50 and 60 Hz and implemented in either shell-wound configuration (primary and secondary windings wound on top of each other around the middle bar or leg 304) or core-wound configuration (the primary and secondary windings are wound around the top leg 306 and bottom leg 308, respectively).

Another configuration, which for convenience will be referred to as a continuous flux path configuration, involves the use of a metal windings or loops that define a continuous flux path. One such configuration, known as the hexaformer configuration is shown in FIG. 4, and is described in greater detail in U.S. patent application Ser. No. 09/623,285, comprises three frames 400, each made up of three metal coils or loops that are angled relative to each other and each comprising multiple metal coil turns that are off-set to define a frusto-conical end. By placing the three loops inside one another and angling them relative to each other, the resultant frame 400 can be forced into engagement with the other frames 400 to define three vertically extending legs 402 located at the corners of a triangle and extending substantially perpendicular to the plane of the triangle and substantially horizontally extending sets of yokes 404, 406 connecting the legs 402 at the top and bottom. As is evident from FIG. 4, the two sets of yokes at the top and bottom have a substantially triangular shape. The particular configuration, shown in FIG. 4, involving 3 loops per frame 400 results in core legs 402 having a substantially hexagonal cross section. It will therefore be appreciated that each frame 400 defines a top and a bottom yoke and two half-legs so as to form completed legs when connected to adjacent frames, and defining a continuous flux path.

As transformer technology evolved, prior to the development of a viable continuous flux path transformer, the efficiency of the transformers was improved by improving the steel used in the core laminations. In particular, thinner metal plates have come to be used and a transition was made in the 1930's and 1940's from non-grain oriented steel to grain oriented silicon steel, the trend gaining increasing momentum in the 1950's when the use of grain oriented steel became the main approach due to the reduced hysteresis losses in grain oriented steel over non-grain oriented steel.

Continuous flux path cores, such as the hexaformer core, in contrast to non-continuous flux path transformers, have always been implemented using grain oriented steel, which has until the present application been considered in the art as the only approach for manufacturing hexaformer cores.

The distinction between grain oriented and non-grain oriented steel is best understood by considering the nomenclature used to define different grades of steel and the nature of the steels. Amongst non-grain oriented steel, M19, M15 and M12 are defined as different grades of steel, M19 providing for the largest grain sizes and M12 for the smallest grain sizes. The grains are a result of the inclusion of silicon impurities into the steel to define polarized molecules. However, each of M12, M15 and M19 provide for no particular orientation of the steel grains. In contrast, grain oriented steel involves the alignment of polarized molecules in a certain direction to provide for higher electromagnetic conductivity of the metal along its length than perpendicularly to its length in a direction along its width. This is achieved by carefully cooling the metal from a liquid state while it is being rolled into sheets, thereby promoting crystal growth. Grain oriented steel currently includes M6, M5, M4, M3, and M2 grades, M2 providing the most organized grain structure and thinnest sheets. Due to the much higher effort involved in producing grain oriented steel, it will be appreciated that these steels are substantially more expensive than non-grain oriented steels. While market conditions cause the price of steel to change, an approximation of the differences in price is useful. At the time of this application M19 is trading at about $0.75/lb, M12 is about $1.05/lb, the price of M6 is about $1.73/lb and M2 is about $2/lb.

Notwithstanding the increased cost involved in using grain oriented steel it is the only approach used in manufacturing continuous flux path cores such as hexaformer cores. In fact, in addition to the material cost involved in using grain oriented steel, there is a robustness issue that has to be considered when dealing with grain oriented steel. Processing of the steel, e.g., cutting and bending damages the grain, thereby affecting the consistency of the material. In order to minimize these effects the steel ideally has to be annealed after it has been worked. This involves large expensive furnaces and high energy costs to produce the 800 degrees Celsius for the 4 to 5 hours required to anneal the steel. Nevertheless, in spite of the increased cost and complexity involved in using grain oriented steel the it has remained the only steel used for continuous flux path cores such as the hexaformer core.

The present invention seeks to provide a new approach to transformer manufacture which runs counter to current teachings and the commonly accepted trends in the art and has the effect of providing substantial cost benefits.

### SUMMARY OF THE INVENTION

According to the invention, there is provided a three phase transformer comprising a continuous flux path core configuration, wherein at least part of the core includes non-grain oriented steel. The continuous flux path core may comprise three frames, each including multiple loops or metal windings and connected to the other frames to define shared legs and a triangularly shaped set of yokes defining the top and bottom of the core. Thus the core configuration may include three legs located at each of three corners of a triangle and extending perpendicular to the plane of the triangle, as well as three top yokes arranged in the form of a triangle and three bottom yokes arranged in the form of a triangle. Each frame may include three metal coils or loops, and by connecting the frame to similar frames on either side, each leg may have a substantially hexagonal cross section. Each loop is typically off-set to define a frusto-conical shape, and the loops forming a frame are placed within one another in an angled configuration to define the frame.

Further, according to the invention there is provided a method of reducing the cost of producing continuous flux path transformer cores, comprising forming three frames from three or more metal coils or loops for each frame, shaping the frames to define leg sections and yokes, and connecting the frames to adjacent frames by connecting the legs of the frames, and avoiding any annealing of the core after shaping the frames and after the frames are connected to each other. The method typically includes the use of non-grain oriented steel to prevent the lack of annealing from impacting the efficiency of the transformer.

### BRIEF DESCRIPTION OF THE DRAWINGS

FIG. 1 is a representation of a delta connection,

FIG. 2 is a representation of a wye connection,

FIG. 3 is a three dimensional view of a prior art E-core,

FIG. 4 is a three dimensional view of a prior art hexaformer core,

FIG. 5 is a three dimensional view of one embodiment of a transformer core of the invention, and

FIG. 6 is a three dimensional view of another embodiment of a transformer core of the invention

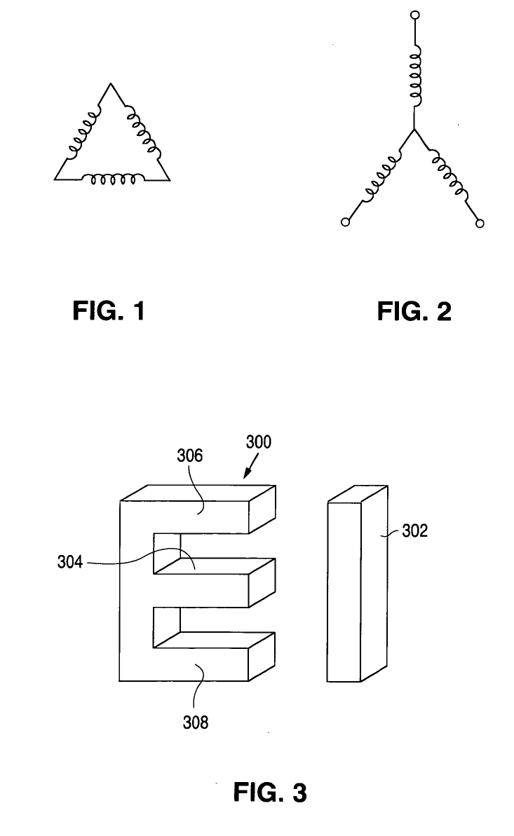

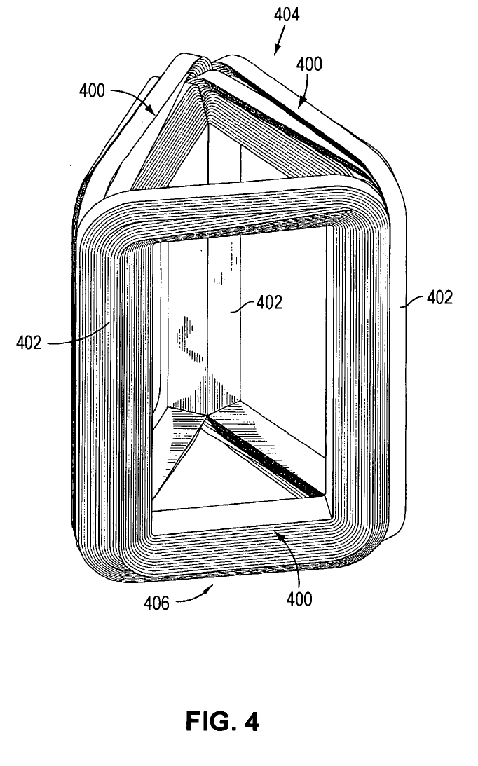

### DETAILED DESCRIPTION OF THE INVENTION

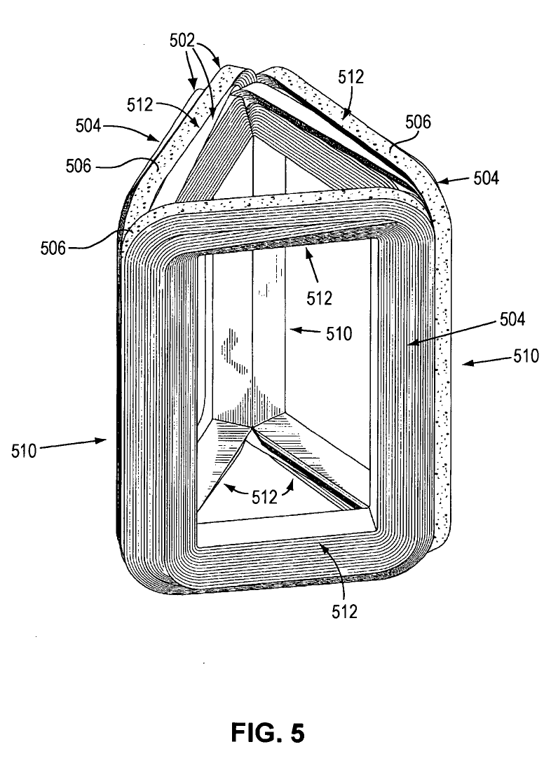

FIG. 5 shows one embodiment of the present invention, making use of a hexaformer core 500 having 3 frames 504, each made up of 3 loops 502, wherein one of the three ferromagnetic steel coils or loops 502 in each of the frames 504 implemented using a non-grain oriented steel as depicted by the use of shading to define the non-grain orientation of the ferromagnetic material used for the one steel coil 506. The steel coils 502 are off-set and angled relative to each other to define frames 504 as is known in the prior art and as is discussed in patent application Ser. No. 09/623,285. Also, as known in the art, the frames 504 are connected to each other to define three legs 510 having a substantially hexagonal cross-section, and top and bottom yokes 512 arranged in the form of a triangle. Thus the legs 510 and yokes 512 define a substantially continuous flux path since there are no sudden flux direction changes as is found in E-cores in which the top, middle and bottom yokes define a flux path with a substantial directional change from the legs of the E-core.

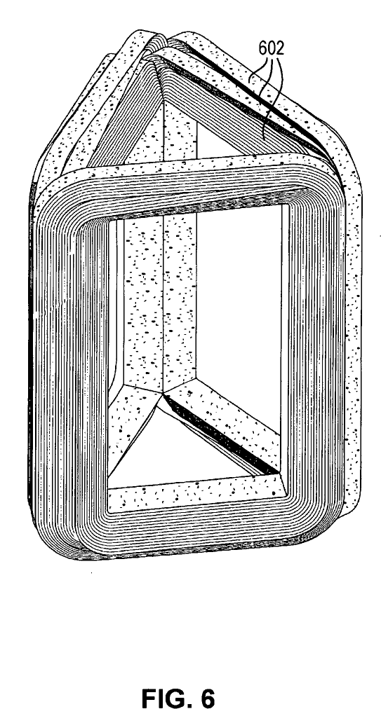

Another embodiment of the invention, shown in FIG. 6, makes use of a similar configuration as in FIG. 5 but, in this case all three of the ferromagnetic steel coils 602 are made of non-grain oriented steel as depicted by the shading for the entire core material. This configuration has the advantage that it avoids all use of grain oriented material, thereby avoiding the susceptibility to damage during manufacture and avoiding the need to anneal the core afterwards. The present invention makes use of this aspect to define a new and more cost effective approach to producing continuous flux path transformer cores. In particular one aspect of the invention involves forming continuous flux path transformer cores using a set of manufacturing steps in which the annealing of the metal after the frames have been shaped and connected to each other, is eliminated altogether. The present invention thus provides a substantial time saving as well as a cost saving from a materials point of view (due to the lower cost of M12, M15, and M19 over grain oriented steels such as M5, M4, M3, and M2). It provides for additional cost benefits by reducing the capital outlay (by avoiding an annealing oven) and reducing energy costs (in maintaining the oven temperature at about 800 degrees Centigrade for 4 to 5 hours.

While the above embodiments describe two different implementations, the invention is not so limited. It will be appreciated that the invention could be implemented in any three dimensional core configuration and making use of non-grain oriented steel in only some of the frames or in different steel coils in each of the frames.

What is claimed is:

1. A three phase transformer core comprising
a continuous flux path core configuration, wherein at least part of the core includes non-grain oriented steel.

2. A transformer core of claim 1, wherein the continuous flux path core comprises three frames, each including multiple loops or metal windings and each connected to the other frames to define shared legs and a triangularly shaped set of yokes defining the top and bottom of the core.

3. A transformer core of claim 2, wherein the core configuration includes three legs located at each of three corners of a triangle and extending perpendicular to the plane of the triangle, as well as three top yokes arranged in the form of a triangle and three bottom yokes arranged in the form of a triangle.

4. A transformer core of claim 2, wherein each frame includes three metal coils or loops, and by connecting the frame to similar frames on either side, each leg may have a substantially hexagonal cross section.

5. A transformer core of claim 4, wherein each loop is off-set to define a frusto-conical shape, and the loops forming a frame are placed within one another in an angled configuration to define the frame.

6. A method of reducing the cost of producing continuous flux path transformer cores, comprising forming three frames from three or more metal coils or loops for each frame, shaping the frames to define leg sections and yokes, and connecting the frames to adjacent frames by connecting the legs of the frames, and avoiding any annealing of the core after shaping the frames and after the frames are connected to each other.

7. A method of claim 6, wherein the method includes the use of non-grain oriented steel to prevent the lack of annealing from impacting the efficiency of the transformer.
